(19) United States
(12) Patent Application Publication
(10) Pub. No.: US 2004/0148245 A1
(43) Pub. Date: Jul. 29, 2004

(54) Incentive driven forecasting method and apparatus for business goals

(76) Inventors: Kay-Yut Chen, Santa Clara, CA (US); Bernardo A. Huberman, Palo Alto, CA (US); Rajan M. Lukose, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/353,657

(22) Filed: Jan. 28, 2003

(51) Int. Cl. G06F 17/60

(52) U.S. Cl. 705/37

(57) ABSTRACT

A method and apparatus is used to forecast a goal in a principal-agent environment. The forecast includes providing an agent with a menu of incentive contracts having a sliding-scale between a fixed compensation portion and a at-risk compensation portion that depends on the agent meeting the goal, requesting the agent select the incentive contract combining the fixed compensation portion with the at-risk compensation portion in accordance with the agents private knowledge of the goal at the time of the selection, and forecasting the likelihood of the goal occuring based on the incentive contract selected by the agent using the agent's private knowledge.

### BACKGROUND OF THE INVENTION

The present invention relates to business forecasting using incentives. Both national and international businesses rely on forecasting for daily operations and ongoing profitability. In general, forecasting is a complicated process. Many variables must be determined in advance including determining a customer demand and then ensuring sufficient supplies and infrastructure exists to deliver the goods and/or services required. If the forecasts are accurate, purchasing can arrange to purchase goods, services, transportation, and other necessities for doing business at favorable rates and under reasonable terms. Moreover, accurate forecasts may facilitate rapid delivery of products/services while reducing the costs otherwise spent on holding inventory or wasted goods.

Conversely, inaccurate forecasting may be very expensive as orders are not met and excess inventories accumulated. The conventional systems assist in forecasting using econometric and statistical extrapolation techniques. To some extent, these forecasting systems rely on a correlation between the recent historical actions and a reproduction of these events in the future. The reliability of statistics and other traditional forecasting techniques often depend upon whether the events or occurrences being forecast are cyclical and/or repeat with regularity.

Conventional forecasting methods are less accurate when the events themselves are not regular or cyclical. For example, business opportunities and one-time business events that do not repeat are generally not readily predicted using conventional forecasting methods. Conventional forecasting methods may have difficulty providing accurate forecasts without additional insights or private information possessed by various business people or others directly involved in the transactions. For example, forecasting revenue in a sales force often depends on knowing the potential sales opportunities presented to the sales team in the field. Aside from repeat customers and sales, this generally requires a sales manager to obtain private information from the sales force concerning potential sales opportunities and the likelihood of those sales occurring or closing in a given measurement period.

Unfortunately, this private information possessed by people in business and other organizations often goes untapped when forecasts and other predictions are being made. For example, a sales person in a quota system is likely to underestimate future sales or low-ball sales estimates in hopes of receiving a relatively low quota the sales person can obtain or exceed. The sales person does not provide private information to the employer as they are not rewarded for their private knowledge. Further, if the sales person is rewarded on accurate forecasts alone then they will not only predict lower sales but meet the lower sales by not working at all.

The dilemma is identified in economic terms as a principal-agent problem and has many associated areas of interest. In the sales force example, the principal is the employer and the sales person acts as the agent to the employer making sales. The problem of obtaining truthful information and inducing hard work are referred to as adverse selection and moral hazard respectively in the economics literature on the subject. Forecasting business events remains difficult because the conventional forecasting systems do not address these and other related problems.

### BRIEF DESCRIPTION OF THE DRAWINGS

FIG. 1 is a block diagram depicting a forecasting system designed in accordance with one implementation of the present invention and used in a principal-agent context;

FIG. 2 provides a flowchart diagram of the operations associated with creating and implementing an incentive contract in accordance with one implementation of the present invention;

FIG. 3 is a flowchart diagram of the operations for implementing the incentive contract in accordance with one implementation of the present invention;

FIG. 4 is a flowchart diagram of the operations for processing historical information related to the agents' incentive contract choices;

FIG. 5 depicts an incentive contract menu implemented in accordance with one implementation of the present invention; and

FIG. 6 is a block diagram of a system used in one implementation for performing apparatus or methods of the present invention.

Like reference numbers and designations in the various drawings indicate like elements.

### DETAILED DESCRIPTION

Aspects of the present invention are advantageous in at least one or more of the following ways. Forecasts are made more accurately without incurring large costs to oversee the management and gathering of data. In a principal-agent context, the principal can rely on implementations of the present invention to improve forecasting of business goals and other metrics without increased oversight or managing of the agents providing the forecasting information.

Carefully designed incentive-contracts implemented in accordance with the present invention facilitate aligning agents with the interests of principals. Individual agents are given the opportunity to use private information they possess to increase the likelihood of receiving higher compensation. For example, a sales agent can use their private information about achieving sales goals to select a more favorable compensation package. In addition, a randomly selected opportunity to update the agent's selection of an incentive-contract from a menu of contracts further motivates the agent to work hard throughout a reporting period for business even when the goals have already been met or conversely seem unattainable. The results are an improvement in the effort put forth by agents working for the principal as well as producing more accurate or truthful information for forecasting purposes from the agent.

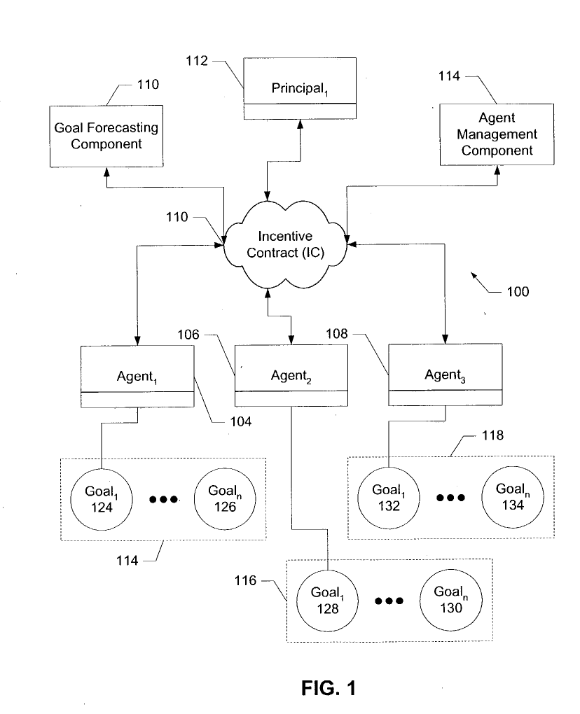

FIG. 1 is a block diagram depicting a forecasting system designed in accordance with one implementation of the present invention and used in a principal-agent context. Forecasting system 100 includes a principal 102, an agent 104, an agent 106, and an agent 108, that work together according to terms and conditions set forth through an incentive contract (IK) component 110. Agent 104, agent 106, and agent 108 each have private information 114, private information 116, and private information 118 respectively. A goal forecasting component 110 and an agent management component 114 are driven according to parameters and information provided by a combination of inputs from incentive contract component 110, agent 104, agent 106, agent 108, in addition to inputs from principal 102.

Principal 102 puts forth incentive contract component 110 in the course of business or other principal-agency relationship to various agents as depicted in forecasting system 100. For example, principal 102 can be an owner/operator of a business and agent 104, agent 106, and agent 108 represent a sales force employed by principal 102 to sell the goods and/or services of the business.

Incentive contract component 110 is a system that receives and manages information from the agents and principal 102 and determines the compensation to be paid to agent 104, agent 106, and agent 108 at regular business intervals (i.e., quarterly, annually, or other agreed upon interval). Principal 102 specifies to incentive contract component 110 a number of different parameters including maximum compensation to be paid to each agent and parameters for setting the incentive contract menu.

In one implementation of the present invention, incentive contract menu in the incentive contract component 110 uses a sliding-scale having a fixed compensation portion and an at-risk compensation portion that depends on the agent meeting one or more goals. Each agent 104, agent 106, and agent 108 selects a point along this sliding-scale to improve their compensation or other remuneration. The structure of this sliding-scale motivates agent 104, agent 106, and agent 108 to base their selection decision according to their respective private knowledge 114, private knowledge 116, and private knowledge 118 and corresponding information about goal 124 to goal 126, goal 128 to goal 130, and goal 132 to goal 134. These goals can represent potential sales opportunities or other events known about primarily by the agents and difficult to obtain directly by principal 102 or the organization affiliated with principal 102. Implementations of the present invention draw this private information from the agents for use in forecasting operations in goal forecasting component 110 and subsequent management tasks with agent management component 114.

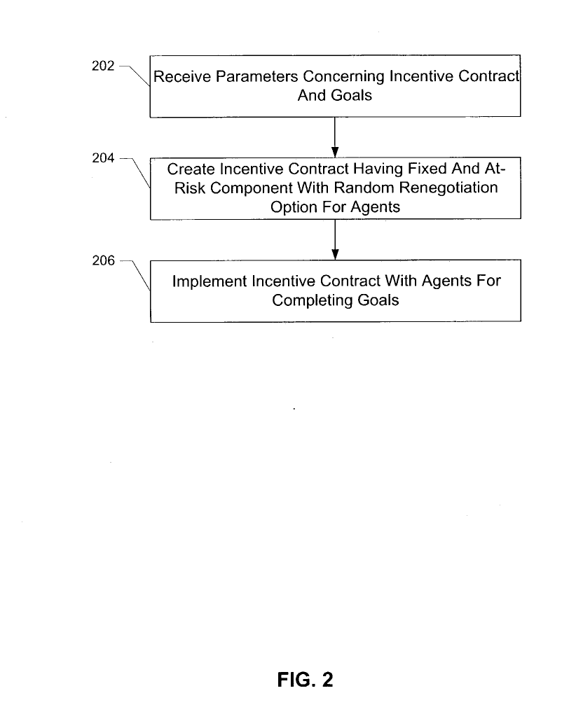

FIG. 2 provides a flowchart diagram of the operations associated with creating and implementing an incentive contract in accordance with one implementation of the present invention. Initially, a principal provides a number of parameters and goals concerning the incentive contract (202). In one implementation, an application used to create the incentive contract model receives and processes parameters including: a maximum compensation, a set of goals, and an intuitive setting for the principal to input intuition on probability of meeting the goal. Optionally, the principal may also provide an assignment of these goals to specific agents, and include historical information to better calibrate each agents probability assessment for the occurrence of certain goals. The calibration factor for each agent is called a behavioral risk parameter and is described in further detail later herein.

In the sales example previously described, the principal or sales manager uses the maximum compensation to ensure that implementations of the present invention do not contribute towards budget overruns or other financial surprises. The set of goals in a sales context would correspond to leads or potential sales that need an agent or sales person's effort for closing. If the principal so desires, it is possible to assign goals to certain agents automatically based on historical performance data for the particular agents.

An incentive contract is created using the information described to have various fixed and at-risk components for compensation (204). In one implementation, the fixed and at-risk components potentially provide the least compensation when the agent selects a smaller at-risk component and higher compensation when the agent selects a greater at-risk. The rate at which the fixed and at-risk components vary depends on the particular application and may be limited by the maximum total compensation. For example, an at-risk component may not contribute additional remuneration when the at-risk component and the fixed component combined exceed the maximum compensation selected. Setting a maximum salary for a sales person of $250,000.00 prevents the person from receiving more than $250,000.00 regardless of the outcome of the sliding-scale associated with the incentive based contract. Once formulated, the incentive contract is implemented and used to improve both forecasting and work efforts among the agents (206).

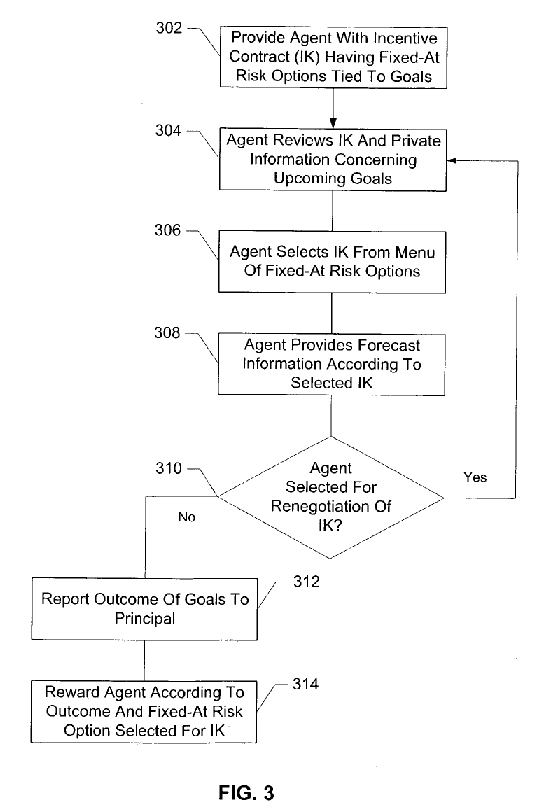

FIG. 3 is a flowchart diagram of the operations for implementing the incentive contract in accordance with one implementation of the present invention. At this point, an optimal incentive contract has been developed to include both fixed and at-risk components in appropriate proportions (302). Aside from providing an agent with a menu of selections, the contract curve describing the fixed and at-risk portions may vary in different amounts including linear, exponential, non-linear, and custom selection functions. In one implementation, it may be desirable to increase the at-risk portion exponentially as the at-risk portion is increased. Alternatively, it may be more advantageous to increase the at-risk portion linearly regardless of how much the at-risk contribution has been selected by the user.

Before selecting a fixed and at-risk portion from the menu of selections, the agent reviews private information concerning upcoming goals (304). In one implementation, the goals are assigned to the particular agent and the agent must research and determine the probability of meeting the goals. Alternatively, the goals are opportunities that the agent has discovered and already has information on; sometimes the agent has the only information on the goal. For example, the agent can be a sales person and the goals the sales opportunities for a particular time interval or business quarter.

Once the agent has gathered and analyzed private and other information, the agent selects an incentive contract from the menu of fixed and at-risk options (306). Because the agent often has private information to better predict obtaining or meeting the goal, the agent's selection from the incentive contract menu more accurately corresponds to the probability of obtaining the goal and can also be used for improved forecasting. Optionally, the agent can also specify an effort level for the different goals in light of the selection from the incentive contract menu. Specifying an increased effort level to meet a goal can also be considered in the incentive contract menu when calculating remuneration for the agent. For example, assigning an increased effort level for a goal that is difficult to obtain can yield more compensation if the goal is met. Alternatively, the incentive contract menu can suggest an effort level for agents to expend on the goal based on the probability assessment and menu selection.

In addition to selecting from the incentive contract menu, the agent may also provide a principal with further information used to forecast the number of goals and the probability of obtaining or meeting these goals (308). In one implementation, the forecasting information could be derived from one or more parameters specified in the incentive contract menu. For example, a probability assessment for a goal can be derived from a calculation using the fixed compensation portion and at-risk compensation portion selected by the agent. Alternatively, the agent can also directly specify a probability assessment of obtaining the goal during the measurement period. The agent is motivated to provide an accurate probability assessment as it would influence the agent's eventual remuneration.

Using a certain probability, an agent may also be given the opportunity to renegotiate or reselect from the incentive contract menu at some later time period prior to the end of the measurement period (310). If selected, the agent can update the selection from the incentive contract menu (306) having increased private and other knowledge about the likelihood of achieving certain goals (304). For example, a sales person may determine the certain sales are more likely to be made and consequently increase their potential remuneration by increasing the at-risk portion of the compensation calculation. Among the many effects, this random renegotiation option further ensures: 1) an agent will still try initially to establish an accurate estimate of probability for each goal as the subsequent opportunity to renegotiate is not certain; 2) the company obtains accurate updates regarding the likelihood of goals well into the measurement period. For example, this is important in sales as it reduces the likelihood of restating revenues or other surprises during the various company reporting periods.

Eventually, the selected incentive contract is compared with the outcome of the goals by the principal (312). In one implementation, the principal uses the incentive contract and goals obtained to determine a total compensation for the agent and evaluate the agent's overall performance. Additionally, goals and results are measured and added to a historical database used to improve forecasting and the interpretation of information provided by the agent.

Each agent is paid according to their selections of fixed and at-risk options in the incentive contract menu and the outcome of the goals (314). Implementations of the present invention not only reward the agent for meeting the goals but also provide remuneration for accurately forecasting the eventual outcomes by way of private information and other resources.

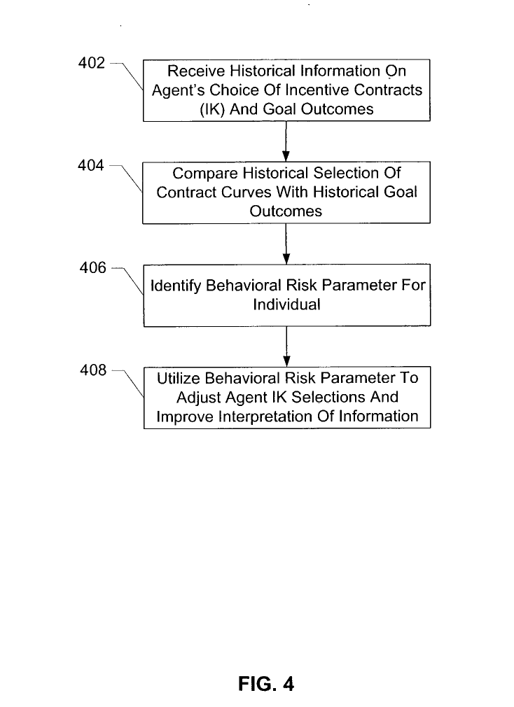

Referring to FIG. 4 is a flowchart diagram of the operations for processing historical information related to the agents' incentive contract choices. In one implementation, an agent's past incentive contract choices can be used to normalize their future incentive contract choices and improve forecasting. Initially, the agent's past incentive contract choices and goal outcomes are received and stored in a historical database or storage area (402). The historical database includes both the fixed compensation portion, the at-risk compensation portion for each goal and the eventual outcome of the goal. This may also include an agent's probability assessment for each goal if one was given at or before the goal could be completed.

For example, the information would include both the deals a sales person closed (i.e., goal attainment), goals a sales person failed to close (i.e., goal not obtained), and a direct or indirect probability assessment provided by the sales person. As previously described, the sales person's probability assessment can be derived from the selections made in the incentive contract or may be made expressly by the sales person.

Historical information for agent's incentive contract selections from the contract menu or contract curve is compared with the historical goal outcomes (404). The ability for the particular agent to accurately predict the outcome of a goal is analyzed through the historical information. Assuming enough samples exist in the historical information, a trend is identified indicating a consistent amount or offset the agent inaccurately predicts goals; this is used to generate a behavioral risk parameter for the individual (406). The behavioral risk parameter is created for each agent as needed and helps assess the agent's ability to provide accurate forecasting data. For example, an agent may inherently provide overly conservative probability assessments for obtaining certain goals. If the agent's goals are met despite the conservative probability assessments, the behavioral risk parameter is created to indicate the agent's propensity to provide conservative probability assessments. The behavioral risk parameter is used by the principal or others to adjust an agent's probability assessments for subsequent goals and improve forecasting (408).

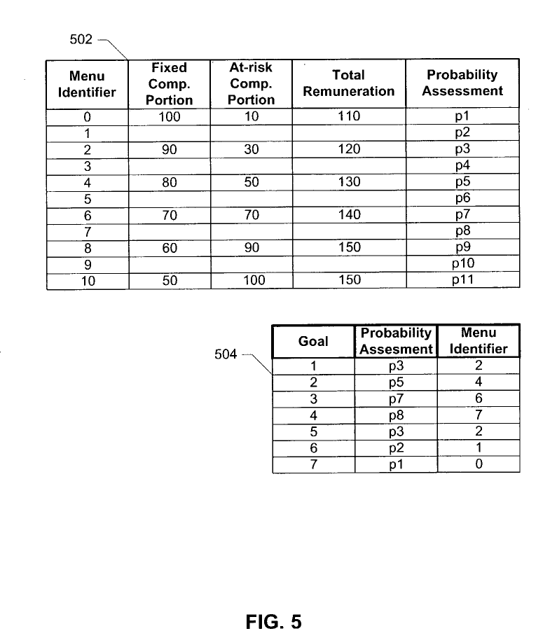

FIG. 5 depicts an incentive contract menu implemented in accordance with one implementation of the present invention. In this implementation, the columns of the incentive contract menu 502 includes: menu identifiers, a fixed compensation portion, an at-risk compensation portion, a total remuneration, and a probability assessment. A separate goal table 504 has columns including: goals, probability assessment for goals, and menu identifiers from the incentive contract menu.

In operation, the agent associates each goal in goal table 504 with a menu identifier from incentive contract menu 502 and the corresponding probability assessment for the particular fixed and at-risk compensation portions identified in incentive contract menu 502. The fixed compensation portion in incentive contract menu 502 is paid to the agent at the end of the measurement period regardless of the outcome of the goal while the at-risk compensation portion is paid only when the goal identified actually happens within the specified measurement period. Assuming the agent wants to maximize wealth, the agent increases the at-risk compensation portion when it is believed that the goal will be attained. Conversely, the fixed portion is more likely to be favored when the agent is uncertain the goal can be attained in the measurement period. Accordingly, the selection from incentive contract menu 502 reflects the private knowledge an agent has about the probability of a goal occurring or not occurring. As previously described, there is also a probability that the agent can update the incentive contract selection from incentive contract table 502 and optimize remuneration especially as the agent's private or other knowledge about the goal increases over time. In one implementation, a predetermined percentage of the agents are selected to update their incentive contract selections at a predetermined point in time during the measurement period.

Deriving an incentive contract menu can be derived with or without providing an agent the ability to renegotiate or reselect the fixed and at-risk terms. These derivations do not take into consideration the agent's associating different goals with varying amounts of effort and assumes the agent wants to maximize wealth. In one implementation, the expected compensation/utility for an agent presented with an incentive contract without a renegotiation probability is:

U(\overline{P},e)=x(\overline{P})+y(\overline{P})P(e)−W(e)+C

Expected Compensation/Utility without Renegotiation (Eq. 1)

Where: C is a constant compensation

P is the true probability associated with a goal

\overline{P} is the reported probability associated with a goal

U(\overline{P},e) is the expected compensation based upon reported probability and effort

W(e) is the disutility of work in accordance with effort

x(\overline{P}) is the fixed payment in accordance with reported probability

y(\overline{P})P(e) is the at-risk payment in accordance with the reported probability and true probability

Differentiating the expected compensation without renegotiation with respect to reported probability and evaluating at the true probability maximizes compensation and further ensures that the agent will provide accurate or truthful information. The probability of receiving truthful information is optimal when the fixed compensation portion represented by x(\overline{P}) and the at-risk compensation portion represented by y(\overline{P})P(e) satisfy the following first order condition:

x′(P)=−y(P)P(e) (Eq. 2)

Of the many possible solutions, one implementation may use the following solution:

x(\overline{P})=a−b\overline{P}² (Eq. 3)

y(\overline{P})=2b\overline{P} (Eq. 4)

Provided a and b are positive constants, the above solution illustrates that the fixed compensation portion (x(\overline{P})) decreases and the at-risk or bonus portion (y(\overline{P})) increases with higher probability. For example, a probability of 1 (i.e., \overline{P}=1) provides the smallest upfront payment of a−b and the largest total payment of a+b. Substituting the suggested solutions above (Eq. 3 and Eq. 4) into the expected compensation function above (Eq. 1) and evaluating the second order condition verifies that the expected compensation function provides a maximum when truthful information is being provide by the agent.

In another implementation, the expected compensation/utility for an agent presented with an incentive contract having a renegotiation probability is:

U(\overline{P},e,\overline{P}′)=q[x(\overline{P}′)+y(\overline{P}′)P(e)]+(1−q)[x(\overline{P})+y(\overline{P})p(e)]−W(e)+C

Expected Compensation/Utility with Renegotiation (Eq. 5)

Where in addition to the terms above:

\overline{P}′ is the reported probability during renegotiation

q is the probability of renegotiation

Through backward induction, it can be shown that an agent proving truthful probabilities both initially and during renegotiation (i.e., both \overline{P} and \overline{P}′ respectfully) tends to maximize the agent's utility in Eq. 5 and consequently their compensation.

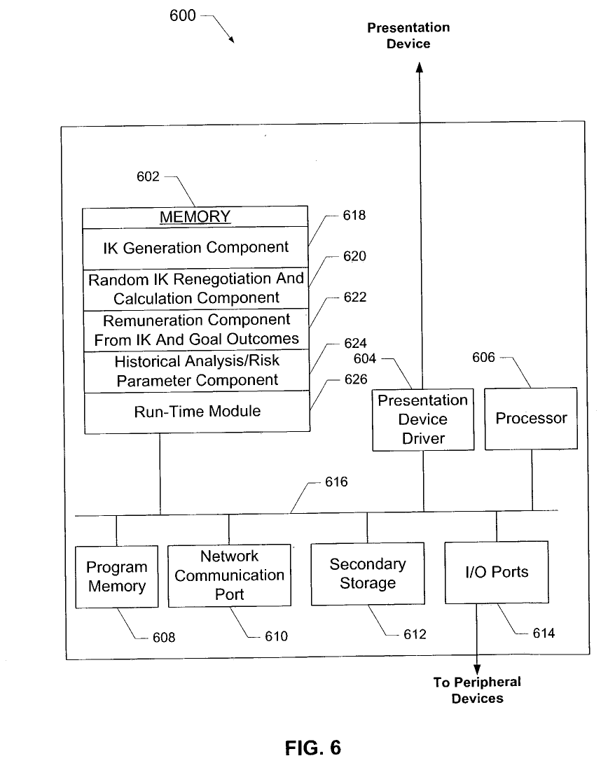

FIG. 6 is a block diagram of a system 600 used in one implementation for performing apparatus or method of the present invention. System 600 includes a memory 602 to hold executing programs (typically random access memory (RAM) or writable read-only memory (ROM) such as a flash ROM), a presentation device driver 604 capable of interfacing and driving a display or output device, a program memory 608 for holding drivers or other frequently used programs, a network communication port 610 for data communication, a secondary storage 612 with secondary storage controller, and input/output (I/O) ports 614 also with I/O controller operatively coupled together over a bus 616. The system 600 can be preprogrammed, in ROM, for example, using field-programmable gate array (FPGA) technology or it can be programmed (and reprogrammed) by loading a program from another source (for example, from a floppy disk, a CD-ROM, or another computer). Also, system 600 can be implemented using customized application specific integrated circuits (ASICs).

In one implementation, memory 602 includes an incentive contract (IK) generation component 618, a random incentive contract renegotiation and calculation component 620, a remuneration component 622, a historical analysis/risk parameter component 624, and a run-time module 626 that manages the resources used on system 600 by implementations of the present invention.

As previously described, incentive contract generation component 618 can be used by the principal to setup and in effect generate the incentive contract. In a sales environment, the principal would want to make sure the agents are compensated both for working hard and providing accurate probability assessments of deals they are likely or unlikely to obtain. Further, the principal also would make sure that the maximum remuneration capable of being provided to one or more agents would not exceed the principal's sales or business budget.

Random incentive contract renegotiation and calculation component 620 determines when a renegotiation between the principal and agent should occur, identifies agents to be given the option to renegotiate, and accounts for differences in the remuneration due to the changed incentive contract menu selections. Remuneration component 622 generally is used to determine the compensation or other pecuniary interest provided to the agent for meeting goals and/or providing accurate forecasts. Historical analysis/risk parameter component 624 facilitates improving the overall forecasting ability by assigning different agents behavioral risk parameters as previously described and used.

While examples and implementations have been described, they should not serve to limit any aspect of the present invention. Accordingly, implementations of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

While specific embodiments have been described herein for purposes of illustration, various modifications may be made without departing from the spirit and scope of the invention. Accordingly, the invention is not limited to the above-described implementations, but instead is defined by the appended claims in light of their full scope of equivalents.

What is claimed is:

1. A method of forecasting a goal in a principal-agent environment, comprising:
providing an agent with a menu of incentive contracts having a sliding-scale between a fixed compensation portion and a at-risk compensation portion that depends on the agent meeting the goal;
requesting the agent select the incentive contract combining the fixed compensation portion with the at-risk compensation portion in accordance with the agents private knowledge of the goal at the time of the selection; and
forecasting the likelihood of the goal occurring based on the incentive contract selected by the agent using the agent's private knowledge.

2. The method of claim 1 further comprising:
randomly allowing the agent to subsequently reselect the incentive contract combining the fixed compensation portion with the at-risk compensation portion based upon the agent's private knowledge at the time of the reselection.

3. The method of claim 1 wherein the fixed compensation portion and at-risk compensation portion corresponds to at least one function selected from a set of functions including: linear, exponential, non-linear, and customized.

4. The method of claim 1 wherein the goal is based upon an opportunity the agent discovered.

5. The method of claim 1 wherein the goal is assigned to the agent by the principal.

6. The method of claim 1 wherein the agent can specify an effort level that the agent plans to expend on obtaining the goal.

7. The method of claim 6 wherein the effort level specified can also be used to determine the remuneration provided to the agent.

8. The method of claim 1 further comprising:
rewarding the agent according to the incentive contract selected by the agent and in consideration of the goal.

9. The method of claim 1 wherein the agent is a salesperson and the forecast involves determining revenue from goals involving sales.

10. The method of claim 1 wherein the private information from the agent includes information concerning the sales of goods or services in the course of sales cycle in a business.

11. The method of claim 1 wherein the forecasting further includes a probability assessment of achieving the goal.

12. The method of claim 11 wherein the probability assessment is a function of the agent's selection in the incentive contract menu.

13. The method of claim 11 wherein the probability assessment is provided by the agent.

14. The method of claim 1 wherein the incentive contract menu without a possibility of renegotiation provides an agent utility described as follows: U(\overline{P},e)=x(\overline{P})+y(\overline{P})P(e)−W(e)+C.

15. The method of claim 2 wherein the incentive contract menu with a possibility of renegotiation provides an agent utility described as follows: U(\overline{P},e,\overline{P}′)=q[x(\overline{P}′)+y(\overline{P}′)P(e)]+(1−q)[x(\overline{P})+y (\overline{P})p(e)]−W(e)+C

16. A method of improving an agent's forecast of a goal in a principal-agent environment, comprising:
receiving historical information on an agent's choice of incentive contracts having a sliding-scale between a fixed compensation portion and an at-risk compensation portion tied to obtaining the goal by the agent;
comparing the historical information on the agent's choices of incentive contracts with historical goal outcomes to determine the agent's individual behavioral risk parameter; and
utilizing the behavioral risk parameter when interpreting the agent's choice of incentive contracts and forecasting the occurrence of a goal.

17. The method of claim 16 wherein the behavioral risk parameter is a measure of the difference between the agent's probability assessment of a goal and the occurrence of the goal.

18. The method of claim 16 wherein the agent is a sales person and the goals involve sales of goods or services.

19. A forecasting system for goals in a principal-agent environment, comprising:
a processor capable of executing instructions;
a processor storing instructions when executed on the processor provide provide an agent with a menu of incentive contracts having a sliding-scale between a fixed compensation portion and a at-risk compensation portion that depends on the agent meeting the goal, request the agent select the incentive contract combining the fixed compensation portion with the at-risk compensation portion in accordance with the agents private knowledge of the goal at the time of the selection, forecasts the likelihood of the goal occurring based on the incentive contract selected by the agent using the agent's private knowledge.

20. The system of claim 19 further comprising instructions stored in memory that,
randomly allow the agent to subsequently reselect the incentive contract combining the fixed compensation portion with the at-risk compensation portion based upon the agent's private knowledge at the time of the reselection.

21. The system of claim 19 wherein the fixed compensation portion and at-risk compensation portion corresponds to at least one function selected from a set of functions including: linear, exponential, non-linear, and customized.

22. The system of claim 19 wherein the agent can specify an effort level that the agent plans to expend on obtaining the goal.

23. The system of claim 19 further comprising instructions in memory that,
reward the agent according to the incentive contract selected by the agent and in consideration of the goal.

24. The system of claim 19 wherein the agent is a salesperson and the forecast involves determining revenue from goals involving sales.

25. The system of claim 19 wherein the private information from the agent includes information concerning the sales of goods or services in the course of sales cycle in a business.

26. A computer program product for forecasting a goal in a principal-agent environment, tangibly stored on a computer-readable medium, comprising instructions operable to cause a programmable processor to:
provide an agent with a menu of incentive contracts having a sliding-scale between a fixed compensation portion and a at-risk compensation portion that depends on the agent meeting the goal;
request the agent select the incentive contract combining the fixed compensation portion with the at-risk compensation portion in accordance with the agents private knowledge of the goal at the time of the selection; and
forecast the likelihood of the goal occurring based on the incentive contract selected by the agent using the agent's private knowledge.

27. The computer program product of claim 26 further comprising instructions to:
randomly allow the agent to subsequently reselect the incentive contract combining the fixed compensation portion with the at-risk compensation portion based upon the agent's private knowledge at the time of the reselection.

28. An apparatus for forecasting a goal in a principal-agent environment, comprising:
means for providing an agent with a menu of incentive contracts having a sliding-scale between a fixed compensation portion and a at-risk compensation portion that depends on the agent meeting the goal;
means for requesting the agent select the incentive contract combining the fixed compensation portion with the at-risk compensation portion in accordance with the agents private knowledge of the goal at the time of the selection; and
means for forecasting the likelihood of the goal occurring based on the incentive contract selected by the agent using the agent's private knowledge.
